(19) United States
(12) Patent Application Publication
(10) Pub. No.: US 2023/0277001 A1
(43) Pub. Date: Sep. 7, 2023

(54) Container Arrangement for a Kitchen Appliance

(71) Applicant: Vorwerk & Co. Interholding GmbH, Wuppertal (DE)

(72) Inventors: Sebastian Jansen, Bochum (DE); Nils Beckmann, Remscheid (DE)

(21) Appl. No.: 18/177,794

(22) Filed: Mar. 3, 2023

(30) Foreign Application Priority Data
Mar. 7, 2022 (EP) 22160543.9

(51) Int. Cl. A47J 43/07; G01D 5/20; B65D 43/02; B65D 55/02

(52) U.S. Cl. CPC A47J 43/0777; G01D 5/204; A47J 43/0727; B65D 43/0202; B65D 55/02; B65D 2251/04

(57) ABSTRACT

The application relates to a container arrangement for a kitchen appliance including a food receiving element and at least one lid configured to close an opening of the food receiving element. The lid is movable relative to the food receiving element between a first operating position and a second operating position, between a first operating position and a second operating position different from the first operating position. The lid includes at least a first magnetic field-based counter element and wherein the food receiving element includes at least one magnetic field-based sensor element connectable to a detection device. The detection device is configured to detect a second operating state of the lid. The magnetic field-based sensor element is configured to output the first sensor datum only upon detection of the first magnetic field-based counter element in the detection range of the magnetic field-based sensor element. The first magnetic field-based counter element is configured in the lid such that the magnetic field-based counter element is in the detection range of the magnetic field-based sensor element only if the lid is in the second operating position.

### CROSS-REFERENCE TO RELATED APPLICATION

This application claims priority to European Patent Application No. 22160543.9 filed Mar. 07, 2022, the disclosure of which is hereby incorporated by reference in its entirety.

### BACKGROUND OF THE INVENTION

### Field of the Invention

The application relates to a container arrangement for a kitchen appliance comprising a food receiving element and a lid corresponding thereto. The application also relates to a kitchen appliance and a method.

### Description of Related Art

From the prior art, food processors are known that are configured to prepare food at least semi-automatically. Such food processors, but also other kitchen appliances, may comprise at least one container arrangement. A container arrangement may comprise a food receiving element, for example in the form of a pot, and at least one lid. The lid is configured to close and cover, respectively, the opening of the pot. The lid can also enable other functions during food preparation or can be used for them.

In particular, it may be necessary for a safe operation of a kitchen appliance that the lid is in a specific operating position with the food receiving element, in particular that it can be locked. It is therefore known from the prior art that a lid can be moved relative to the food receiving element from a first operating position, such as an unlocked operating position, to a second operating position, such as a locking operating position. For example, the user may move the lid accordingly or the kitchen appliance may comprise a lid drive configured to (automatically) move a lid at least between the unlocked position and the locking position.

The conduction of a specific kitchen appliance function by a kitchen appliance is regularly only permissible when (respectively if) a lid on the food receiving element is in a specific operating position, in particular the locking position, i.e., the container arrangement is in a second operating state, in particular the locking state.

It is known from the prior art to use microswitches in order to recognize and detect, respectively, a locking state of a container arrangement. For example, the locking position of the lid can be detected by interrogating the position of the locking rollers of the food receiving element/lid by means of the microswitches in combination with an evaluation of the current requirement of the lid drive. In addition, a microswitch is usually used, which must be actuated by a locked lid.

Furthermore, concepts are known from the prior art that also detect a lid in the locking position by means of electrical switches. Depending on the kitchen appliance, such an electrical switch is actuated directly by the lid or indirectly by means of mechanical plungers, levers or the like.

However, these detection mechanisms have various disadvantages. In particular, the effort of implementation is costly. This is in particular true in the case when the kitchen appliance comprises a plurality of container arrangements and/or the container arrangement comprises a plurality of lids.

In the known detection mechanisms, in order to transmit the locking information from a lid area to a detection device arranged in an appliance base, a transmission path must be provided which transmits the locking information to the corresponding coupling point of the appliance base. Furthermore, the locking information must be provided in the form of one or more electrical signals so that the detection device can evaluate this information in order to be able to detect the locking state.

The different and known detection mechanisms can essentially be divided into two groups. The classification can depend in particular on the point of the kitchen appliance at which the electrical signal is generated that contains and/or represents the locking information (i.e., in particular: lid is in the locking position).

In the first group, the locking information is transmitted mechanically between the container arrangement and the appliance base of the kitchen appliance. The conversion into an electrical signal only takes place in the appliance base.

A corresponding detection mechanism, in particular with different pot diameters respectively food receiving element diameters is associated with the challenge of transmitting the mechanical movement to the correct position of the appliance base. The mechanical transmission elements required for this are subject to a high risk of contamination due to the moving parts. In particularly unfavorable cases, contamination can cause the mechanical mechanism to jam and/or block. This in turn can lead to a faulty locking detection.

In addition, cleaning the mechanical mechanism can be difficult, in particular when filigree, mechanical structures are used for reasons of installation space.

If, in addition to the locking state of the container arrangement, a possibility is to be provided to determine the lid type from a plurality of possible different lid types (e.g., in the case of several different lids per pot), the detection signal must be codable in a suitable manner.

In the case of mechanical scanning of the lid, this leads to a significant additional effort. The reason for this is in particular that in order to transmit the additional information, either the number of signals must be increased (which requires additional mechanical transmission mechanisms) or a mechanical movement of an element of the mechanical mechanism must be evaluated in more detail (e.g., different plunger strokes depending on the type of lid).

Depending on the design, mechanical transmission elements also entail an increased risk of manipulation. For example, the corresponding switches and/or mechanisms can be manually operated by a user to feign locking. Additional mechanical structures are required to prevent this. This in turn makes cleaning even more difficult and also increases the implementation effort.

In the second group, the locking state of the lid is electrically transmitted between the container arrangement and the appliance base. In other words, the conversion into an electrical signal already takes place at the container arrangement. Due to the environmental conditions (e.g., moisture, dirt, temperature, dishwasher environment) to which a container arrangement is regularly exposed, scanning the lid using microswitches is problematic. The reason for this is that the microswitches require a seal. This leads to an increased implementation effort. In addition, a seal is a wear element. Wear can have a particularly negative effect on the service life of the container arrangement.

The described detection mechanisms thus have disadvantages in the fields of robustness, complexity and/or installation space.

### SUMMARY OF THE INVENTION

Therefore, it is the object of the application to provide a possibility for detecting a second operating state, in particular a locking state, in a container arrangement for a kitchen appliance, which is more robust and/or simpler and/or requires less installation space.

According to a first aspect of the application, this object is solved by a container arrangement for a kitchen appliance as described herein. The container arrangement comprises a food receiving element. The container arrangement comprises at least one lid. The lid is configured to close an opening of the food receiving element. The lid is movable relative to the food receiving element between a first operating position and a second operating position different from the first operating position. The lid comprises at least a first magnetic field-based counter element. The food receiving element comprises at least one magnetic field-based sensor element connectable to a detection device. The detection device is configured to detect a second operating state (and the second operating position, respectively) of the lid based on a first sensor datum. The magnetic field-based sensor element is configured to output the first sensor datum only upon detection of the first magnetic field-based counter element in the detection range of the magnetic field-based sensor element. The at least one first magnetic field-based counter element is arranged in the lid such that the magnetic field-based counter element is in (respectively within) the detection range of the magnetic field-based sensor element at least if (respectively when) the lid is in the second operating position.

In contrast to the prior art, according to the application a possibility for detecting a second operating state, in particular a locking state, of a lid of a container arrangement for a kitchen appliance is provided which is more robustly and simply formed and in particular requires less installation space, in that at least one counter element is arranged in the lid and at least one sensor element corresponding thereto is arranged in the food receiving element, wherein the sensor element in particular only emits a first sensor datum if the lid is in the second operating position, in particular in the locking position. Particularly preferably, the sensor element is a coil and the counter element is an induction element, or the sensor element is a magnetic field sensor and the counter element is a magnet, as will be explained in more detail.

The container arrangement according to the application is configured for use in a kitchen appliance. The kitchen appliance is in particular a food processor configured to prepare food and/or beverages. The preparation can be at least partially automated.

The container arrangement comprises at least one food receiving element and at least one first lid corresponding structurally to the food receiving element. This means in particular that a (pot) opening is closable and coverable, respectively, by the first lid and the lid is in particular placeable on the pot opening.

A food receiving element is in particular configured to receive food and is preferably a pot, also called a cooking pot, a pan or the like. In particular, according to the application, a food receiving element is understood to be a fillable vessel or a fillable container which is configured to prepare food or beverages, in particular to cook or boil hot food.

Preferably, the food receiving element corresponds (structurally) to an appliance base of the kitchen appliance. For example, the food receiving element can be at least partially made of plastic, at least partially made of metal and/or at least partially made of glass.

According to the application, a lid means in particular a closure element and/or cover element with which the opening of the feed receptacle element is at least partially (e.g., completely) closeable and coverable, respectively. The lid can in turn have a lid opening, for example for an arrangement, in particular coupling, of an accessory.

According to the application, the lid is movable between at least a first operating position and a second operating position. The first operating position can be a lid position in which the container arrangement is not ready for operation, and the second operating position can be a lid position in which the container arrangement is ready for operation. In the first operating position, the lid is positioned in particular non-operationally on the food receiving element. The lid and the container arrangement, respectively, is in particular in a first operating state. In the second operating position, the lid is positioned in particular ready for operation on the food receiving element. The lid and the container arrangement, respectively, is in particular in a second operating state.

The first operating position can preferably be an unlocked operating position and the second operating position can be a locking operating position.

Preferably, the lid can be locked to the food receiving element. In particular, the first lid is movable relative to the food receiving element between an unlocked position and a (defined) locking position. In the locking position, the lid and the container arrangement, respectively, is in a locking state. A locking according to the application is in particular a mechanical locking or blocking of the lid.

Preferably, the container arrangement may comprise at least one (mechanical) locking mechanism configured to lock the first lid to the food receiving element in a locking position and locked position, respectively, of the lid. For example, the locking may be established by means of at least one clamping element (e.g., roller) arranged on the food receiving element (in a known manner). In particular, a bayonet-type locking may be provided. It shall be understood that other locking mechanisms may be used.

A lid can be moved automatically by a lid drive and locking actuator, respectively, or manually by a user action from the first operating position to the (defined) second operating position.

According to the application, it has been recognized that a second operating state, in particular a locking state, can be detected in a simple manner if one or more contactlessly operating sensor elements are arranged in the pot and one or more counter elements are arranged in the lid in such a way that the sensor element is influenced by a counter element at least in the second operating position, in particular only in the second operating position, i.e. in particular in the locking state of the lid. In particular, the at least one counter element can be arranged in respectively on the lid in such a way that the counter element can only enter the detection range and sensor range, respectively, of the sensor element arranged in respectively on the food receiving element if the lid is (properly) positioned on the food receiving element (e.g. is properly moved from the first operating position into the second operating position), in particular is locked.

In the present case, magnetic field-based means in particular that by a magnetic field-based counter element a detectable influence on the magnetic field-based sensor element is effected. Preferably, by the magnetic field-based sensor element a magnetic field change in the detection range of the sensor element can be detected by a counter element corresponding to the sensor element. In other words, a counter element is in particular configured to influence a magnetic field in the detection range of a sensor element. A sensor element is in particular configured to detect a magnetic field change in the detection range of the sensor. A magnetic field change in the detection range comprises in particular that a magnetic field is detected in the detection range (e.g., if no magnetic field is present in the unlocked state).

The magnetic field-based sensor element is configured to output a first sensor datum. Preferably, a first sensor signal can be output, which in particular can contain and/or represent the first sensor datum. In particular, the first sensor datum is generated and emitted by the sensor element only if the counter element is positioned in the detection range of the sensor element, i.e., in particular if a (specific) magnetic field change is detected.

The detection range means in particular a range around a sensor element in which a counter element causes a (sufficient) change of a magnetic field. Preferably, a detection range of a sensor element can be in the range between 0.01 cm and 5 cm, in particular between 0.5 cm and 3 cm.

The detection device may preferably be arranged in an appliance base of the kitchen appliance. In other embodiments, the food receiving element may at least partially comprise the detection device. The detection device is configured to evaluate at least the first sensor datum. In particular, the detection device may detect and determine, respectively, a second operating state, such as a locking state, upon receipt of the first sensor datum.

Preferably, a specific function of the kitchen appliance can be released for a user depending on a detected and determined, respectively, second operating state of a lid, for example a locking state of the lid, in which the lid is positioned ready for operation on the food receiving element. This means in particular that the function can only be released when the second operating state is detected. Upon detection of a first operating state, for example a non-locking state, in which the lid is not positioned ready for operation on the food receiving element the function can be blocked and remain blocked, respectively. The safety of the operation of the kitchen appliance can be improved.

According to one embodiment of the container arrangement according to the application, the food receiving element may comprise at least two magnetic field-based sensor elements arranged at an upper edge of the pot. The two magnetic field-based sensor elements may be arranged at substantially opposite sides of the edge of the pot. The lid may comprise at least two first magnetic field-based counter elements arranged at a lid edge. The counter elements are in particular aligned with the sensor elements. The two magnetic field-based counter elements may be arranged at substantially opposite sides of the lid edge. By arranging the sensor elements at opposite sides, the risk of mutual interference is reduced. Furthermore, the distance between a counter element and a sensor element can be minimized due to the respective positioning in edge regions in the second operating position. The reliability of the position detection can be further improved.

Preferably, the first magnetic field-based sensor element can be configured to output the first sensor datum only upon detection of the first magnetic field-based counter element in the detection range of the first magnetic field-based sensor element. The further first magnetic field-based sensor element may be configured to output a further first sensor datum only upon detection of the further first magnetic field-based counter element in the detection range of the further first magnetic field-based sensor element.

The at least two first magnetic field-based counter elements can be arranged in the lid in such a way that the respective first magnetic field-based counter element is only in the detection range of the respective magnetic field-based sensor element if the lid is in the second operating position or is (properly) moved into the second operating position.

The detection device can in particular be configured to detect the second operating state based on the first sensor datum and the further first sensor datum. In particular, a second operating state, such as a locking state, can only be detected by the detection device if the two defined signals, i.e., the first sensor datum and the further sensor datum, are received by the detection device. This further increases the reliability of the detection.

According to a further preferred embodiment of the container arrangement according to the application, the lid may comprise at least one magnetic field-based additional counter element. The detection device may be configured to detect the first operating state, such as an unlocked state, of the lid based on a second sensor datum. The magnetic field-based sensor element may be configured to output the second sensor datum only upon detection of the second magnetic field-based additional counter element in the detection range of the magnetic field-based sensor element. The at least one magnetic field-based additional counter element can be arranged in the lid in such a way that the magnetic field-based additional counter element is only in the detection range of the magnetic field-based sensor element if the lid is in the first operating position.

Advantageously, not only a defined second operating state, such as a locking state, but also a further defined first operating state, such as an unlocked state, can be detected. In particular, the at least one additional counter element (can be formed like a counter element) is arranged in respectively on the lid in such a way that the additional counter element can only enter the sensor range and detection range, respectively, of the sensor element arranged in respectively on the food receiving element if the lid is in a defined first operating position on the food receiving element. From this first operating position, the lid can be moved (automatically or by the user) into the second operating position, for example by a rotary movement in particular bayonetted. A reliable distinction can be made between different lid positions, such as unlocked lid position and locked lid position.

Particularly preferred the magnetic field-based detection is an induction-based detection. The induction-based detection principle is based in particular on a detection of the second operating position of the lid by evaluating the inductance value of one or more electrical coil(s). The coils are arranged as sensor elements on the food receiving element and are connected to the appliance base, in particular via electrical lines and contacts, when the food receiving element is positioned on the base. Induction elements are arranged on the lid to interact with the coils. In particular, an induction element is configured to influence the inductance of a coil in a defined manner. The arrangement of an induction element on the lid is preferably selected in such a way that the coil value is only influenced when the lid reaches the defined second operating position on respectively at the food receiving element or is (properly) moved into the second operating position, i.e., the induction element is in the detection range of the coil.

According to a particularly preferred embodiment of the container arrangement according to the application, the at least one magnetic field-based sensor element may be a coil. The at least one first magnetic field-based counter element may be an inductive element formed from an inductance-influencing material. The coil may be configured to generate a magnetic field. The generated magnetic field may substantially form the detection range. For example, a coil may be connected to the detection device. The detection device may comprise a current generator configured to provide a current. The current flow through the coil may cause a generating of the magnetic field.

When an induction element according to the application enters the magnetic field of the coil, this is detected by the coil. In particular, said first sensor datum is output. In particular, an induction element located in the detection range causes a change in current or a change in the inductance of the coil. The detection device can in particular determine the inductance. The inductance generated by the induction element represents in particular the first sensor datum.

If a counter element and an additional counter element in the form of an inductance element and an additional inductance element (different from the inductance element) are arranged in the lid, the first sensor datum may be an inductance and the second sensor datum may be an additional inductance. The value of the inductance and the value of the additional inductance may differ from each other.

According to a preferred embodiment of the container arrangement according to the application, the inductance-influencing material may be a metal. Particularly preferably, the metal may be selected from the group comprising soft magnetic metal (e.g., iron) and non-magnetic metal (e.g., aluminum). It shall be understood that other electrically conductive materials may be used in other variants of the application. For example, a first inductance element may be made of a first metal and a further inductance element may be made of a further metal. This results in different inductance values.

Furthermore, an induction element can be a flat element and a plate-shaped element, respectively. In particular, the flat element can be a metal plate.

In principle, the flat element can have any shape, in particular outline or contour. The flat element can be rectangular, for example. The shape of the flat element can in particular be oriented to the shape of the lid edge and be adapted to it, for example be curved accordingly.

Preferably, the flat element may have a surface with a size between 0.25 cm² and 25 cm², preferably between 0.5 cm² and 8 cm².

According to a further preferred embodiment of the container arrangement according to the application, the container arrangement may comprise at least one first lid and one second lid different from the first lid. In other words, the first lid may be a first type of lid and the second lid may be a second type of lid. In particular, the first lid may be configured for a first kitchen appliance function, the second lid may be configured for a second kitchen appliance function, and in particular the first kitchen appliance function may be different from the second kitchen appliance function. Exemplary kitchen appliance functions are a first cutting function with a first maximum permissible speed and/or torque, a further cutting function with a second (different from the first maximum permissible speed and/or torque) maximum permissible speed and/or torque, a first stirring function with a first maximum permissible speed and/or torque, a further stirring function with a second (different from the first maximum permissible speed and/or torque) maximum permissible speed and/or torque, a first direction of motor rotation, a second opposite direction of motor rotation, a first set temperature and/or a first set temperature range of a heater integrated in the food receiving element, a second set temperature (different from the first set temperature) and/or a second set temperature range (different from the first set temperature range) of a heater integrated in the food receiving element, control programs and/or control program set parameters for specific operations, etc.

The at least one first induction element of the first lid and the at least one second induction element of the second lid can differ from each other. This enables not only the detection of a locking state of the respective lid, but additionally an identification of the lid and type of lid, respectively, arranged on the food receiving element in the second operating position.

In particular, the at least one first inductive element may be made of a first inductance-influencing material and the at least one second inductive element may be made of a second inductance-influencing material different from the first inductance-influencing material. As has already been described, different materials can influence the magnetic field in different ways. This results in particular in a different inductance of the coil, which can be detected by the detection device and evaluated in particular for identification. In a simple way, a type of lid can be identified.

Alternatively or additionally, the shape and/or dimension of the first induction element may differ from the shape and/or dimension of the second induction element. Induction elements with different shapes and/or dimensions can influence a magnetic field in different ways. This results in particular in a different inductance of the coil, which can be detected by the detection device and evaluated in particular for identification. In a simple way, a lid type can be identified.

Furthermore, as an alternative and/or in addition to the material, shape and/or dimension, the arrangement position of the first induction element in the first lid may differ from the arrangement position of the second induction element in the second lid, in each case with respect to the second operating position. In particular, the induction curve of the coil that can be detected during the movement from the first operating position to the second operating position can be influenced by different arrangement positions. This results in particular in different inductance curves for different lids, which can be detected by the detection device and evaluated in particular for identification. A lid type can be identified in a simple manner.

According to a further preferred embodiment of the container arrangement according to the application, the first lid may comprise a plurality of first induction elements. The second lid may comprise a plurality of second induction elements. The plurality of first induction elements may be made of a first combination of materials. The plurality of second induction elements may be made of a second combination of materials different from the first combination of materials. Each type of lid (of a container arrangement according to the application) may be coded with a (system-wide unique) combination of materials. This allows to increase the number of identifiable lid types in a simple way. For example, in a preferred embodiment with two opposing induction elements (induction element 1 and induction element 2), a reliable differentiation of four lid types can be achieved if the four lids are coded according to Table 1 below:

TABLE 1

| | Induction element 1 | Induction element 2 |
|---|---|---|
| Lid type 1 | Material 1 | Material 2 |
| Lid type 2 | Material 2 | Material 1 |
| Lid type 3 | Material 1 | Material 1 |
| Lid type 4 | Material 2 | Material 2 |

Preferably, the first material can be a soft-magnetized metal (in particular iron) and the second material a non-magnetic metal (in particular aluminum).

According to a further embodiment of the container arrangement according to the application, the coil may comprise a coil core in the form of a U-shaped yoke and at least one coil winding wound around the coil core. The food receiving element may comprise a coil cover. Only the ends of the U-shaped yoke may protrude through a respective opening in the coil cover. Preferably, the yoke may be made of a soft magnetic metal. For example, the U-shaped yoke may be a bent sheet. The cover can in particular be a plastic cover. This allows an inconspicuous integration in the food receiving element.

In particular, the coil can be arranged in the food receiving element in such a way that the ends of the U-shaped yoke point radially outwards from the (vertical) top axis and, in particular, are directly opposite the induction element in a second operating position of the lid.

The ends of the yoke can preferably protrude through recesses in the coil cover. This makes it possible to provide the smallest possible distance to the associated induction element in the second operating position of the lid. This has a particularly positive effect on the signal strength. Thus, the smallest possible gap can be provided between the induction element (e.g., metal plate) and the coil yoke. The reliability of the detection and/or identification can be further improved.

According to one embodiment of the container arrangement according to the application, the food receiving element may comprise at least two coils (preferably arranged at opposite pot edge sides). The food receiving element may comprise a first electrical pot connection between a first coil contact of the first coil and a first lower pot contact. The food receiving element may have a second electrical pot connection between a first coil contact of the second coil and a second lower pot contact. The food receiving element may have a third electrical pot connection between a second coil contact of the first coil and a third lower pot contact. The food receiving element may have a fourth electrical pot connection between a second coil contact of the first coil and a fourth lower pot contact. The lower pot contacts may be configured to electrically connect to a detection device.

A corresponding embodiment enables the transmission of the respective sensor signals, containing at least the first sensor datum (e.g., in the form of a specific electrical variable (e.g., current, voltage and/or inductance), to the detection device in a safe manner.

According to a preferred embodiment of the container arrangement according to the application, the food receiving element may comprise at least two coils. The food receiving element may have a first electrical pot connection between a first coil contact of the first coil and a first lower pot contact. The food receiving element may have a second electrical pot connection between a first coil contact of the second coil and a second lower pot contact. The food receiving element may have a third electrical pot connection between a second coil contact of the first coil and a third lower pot contact. The food receiving element may have a fourth electrical pot connection between a second coil contact of the first coil and the third lower pot contact. The three lower pot contacts may be configured to electrically connect to the detection device.

An electrical connection between the at least two coils and the detection device can be provided in a low-effort manner. In particular, the coils in the present embodiment comprise a common (third) pot contact. The pot contacts may be connectable to corresponding base contacts of the appliance base. Thus, the third, common pot contact can be led to a third base contact and the other two coil contacts can each be led separately to the appliance base (via corresponding base contacts) via the respective pot contacts. This has the advantage that the at least two coils can be evaluated individually by a corresponding measuring circuit and measuring module, respectively, in the detection device so that inductance changes can be clearly assigned to the individual coils and the necessary number of contacts can be reduced at the same time.

According to a further preferred embodiment of the container arrangement, the food receiving element may comprise at least two coils. The food receiving element may have a first electrical pot connection between a first coil contact of the first coil and a first lower pot contact. The food receiving element may have a second electrical pot connection between a second coil contact of the second coil and a second lower pot contact. The food receiving element may have a fifth electrical pot connection between a second coil contact of the first coil and a first coil contact of the first coil. The two lower pot contacts may be configured to electrically connect to the detection device. In other words, the at least two coils may be connected in series. This can further reduce the number of contacts and the necessary electrical connections.

The series connection of the coils offers in particular the possibility to manage with only two contacts to the appliance base. If the two induction elements are arranged in the lid in such a way that, in particular if the lid is closed, i.e., when the lid is moved from a first operating position to the second operating position, first (only) the first induction element and then additionally also the further induction element influence the respective coil, then the inductance of the series connection increases in two stages. By evaluating the temporal curve of the total inductance (sum inductance), it can then be checked whether the lid is in the correct (second) operating position on both sides.

In particular, the at least two lower pot contacts may be arranged at the pot bottom. The at least two lower pot contacts can correspond to at least two base contacts arranged in the appliance base. A respective electrical base connection may extend from the respective base contact to the detection device arranged in the appliance base. Preferably, an appliance controller may comprise the detection device.

The appliance base can comprise a pot receptacle. An electrical connection between a respective lower pot contact and a base contact corresponding thereto can in particular (only) be established if the food receiving element is (properly) arranged in the pot receptacle. The pot receptacle is configured to receive the food receiving element, in particular at least the bottom of the food receiving element. The pot receptacle can correspond to the food receiving element of the container arrangement in such a way that an electrical connection between the respective lower pot contact and a base contact corresponding thereto is only established if the food receiving element is (correctly) arranged in the pot receptacle.

As has already been described, in further variants of the application, the food receiving element can at least partially comprise the detection device. In this case, the at least two lower pot contacts can also be arranged at a different location and, in particular, be (directly) connected to the detection device.

According to a further preferred embodiment of the container arrangement according to the application, the at least one magnetic field-based sensor element may be a magnetic field sensor. The at least one magnetic field-based counter element may be a magnet. Preferably, the at least one magnetic field sensor may be selected from the group comprising Hall sensor and reed switch. If a magnet enters the detection range of the magnetic field sensor, the magnetic field generated by the magnet can be detected by the magnetic field sensor. In particular, a change in the magnetic field is detected. A corresponding first sensor datum can be output by the magnetic field sensor and in particular transmitted to the detection device, for example via a wired connection. A locking state can be detected in a simple and reliable manner.

This embodiment can be used in particular as an alternative to the induction-based concept. However, a combination of the concepts is also possible in variants of the application.

According to a preferred embodiment of the container arrangement according to the application, the container arrangement may comprise at least a first lid and a second lid different from the first lid. The at least one first magnet of the first lid may be arranged in the first lid such that the magnetic field sensor detects a first magnetic field with a first magnetic field direction in the second operating position of the first lid. In particular, the orientation of the north pole and south pole of the first magnet may be defined according to a first orientation. The at least one second magnet of the second lid may be arranged on the second lid such that the magnetic field sensor detects a second magnetic field with a second magnetic field direction different from the first magnetic field direction in the second operating position of the second lid. In particular, the orientation of the north pole and south pole of the second magnet may be defined according to a second orientation opposite to the first orientation. The different magnetic field directions result in particular in different sensor signals and sensor signal contents, respectively. In a safe manner, at least two lid types can be identified.

In addition, the first lid may have a plurality of first magnets. The second lid may have a plurality of second magnets. The plurality of first magnets may be arranged in a first pole position combination in the first lid. The plurality of second magnets may be arranged in a second pole position combination different from the first pole position combination in the second lid. This allows the number of identifiable lid types to be increased in a simple manner. Each type of lid (of a container arrangement according to the application) may be coded with a (system-wide unique) pole position combination. For example, in a preferred embodiment with two opposing magnets (magnet 1 and magnet 2 respectively left magnet and right magnet), a reliable differentiation of four lid types can be achieved if the four lids are coded according to Table 2 below:

TABLE 2

| | Magnet 1 (pole alignment) | Magnet 2 (pole alignment) |
|---|---|---|
| Lid type 1 | NP-SP | NP-SP |
| Lid type 2 | NP-SP | SP-NP |
| Lid type 3 | SP-NP | NP-SP |
| Lid type 4 | SP-NP | SP-NP |

Here NP represents the north pole and SP represents the south pole.

A further aspect of the application is a kitchen appliance. The kitchen appliance comprises a container arrangement as previously described. The kitchen appliance comprises an appliance base comprising a detection device connectable to the at least one magnetic field-based sensor element of the lid of the container arrangement. The detection device is configured to detect a second operating state of the lid (and second operating position, respectively) of the container arrangement based at least on an output first sensor datum (and in particular a position criterion, such as a locking criterion).

Preferably, the kitchen appliance may comprise a pot receptacle corresponding to the food receiving element of the container arrangement. The pot receptacle is configured to receive the food receiving element, in particular at least the bottom of the food receiving element. The pot receptacle can correspond to the food receiving element of the container arrangement in such a way that an electrical connection between the respective lower pot contact and an electrical base contact of the appliance base corresponding thereto can only be established if the food receiving element is (correctly) arranged in the pot receptacle.

As has already been described, the detection device may be configured to detect a second operating state of the lid (respectively the second operating position), in particular a locking state of the lid and the container arrangement, respectively, based on a received first sensor datum. In particular, the at least one (previously described) first sensor datum indicates that the lid has been (correctly) moved into the second operating position.

In particular, in the case that the received first sensor datum fulfils a (predefined) position criterion (for example, a specific variable range, such as a voltage, current, and/or induction range and/or a specific minimum magnetic field strength and/or a specific magnetic field direction), it can be determined and detected, respectively, that the lid is (properly) positioned on the food receiving element, preferably locked, i.e. that a locking state of the container arrangement is present. As has been described, in particular a pre-described induction value can be determined by the detection device as a first sensor datum. In particular, if the induction value fulfils the position criterion, the second operating state is detected. In particular, if the induction value does not fulfil the position criterion, the first operating state (different from the second operating state), such as an unlocked state, is detected.

Alternatively or additionally, a magnetic field strength value can be determined. If the magnetic field strength value fulfils the position criterion (for example a minimum magnetic field strength value), the second operating state is detected. If the magnetic field strength value does not fulfil the position criterion, the first operating state is in particular detected.

According to one embodiment of the kitchen appliance according to the application, a plurality of lid type criteria may be predefined and a (different) lid type may be associated with each of the lid type criteria. The detection device may be configured to identify the lid type based on at least one sensor signal received from the at least one magnetic field-based sensor element and the lid type criteria.

The sensor signal can contain at least the first sensor datum. In particular, it can be checked whether or not the first sensor datum (e.g., a measured inductance, a measured magnetic field direction or a corresponding electrical variable, etc.) fulfils the lid type criterion (e.g., a predefined quantity range, in particular inductance range, or a predefined magnetic field direction). In particular, the detection device may be configured to identify the lid type based on a comparison of, for example, a measured inductance, a measured magnetic field direction, etc. and the plurality of lid type criteria. For example, the lid type criterion may be a predefined inductance range for a specific lid type. If the determined inductance value of the lid in the second operating position is within the inductance range of a specific lid type, the lid type can be identified as the specific lid type.

In particular, a lid type criterion can be uniquely assigned to each lid type. Different lid types can be identified in a unique way. The lid type criteria can be based on Table 1 or 2, for example.

In particular, in this embodiment, the position criterion can also be formed by the lid type criterion.

According to a further embodiment of the kitchen appliance according to the application, the kitchen appliance may comprise at least one (visual) display configured to display the identified lid type. This can provide feedback to the user. If the wrong type of lid has been identified due to dirt, for example, the user can be prompted to clean the edge area of the pot and lid, respectively.

Preferably, a specific appliance function of the kitchen appliance is released depending on the identified lid type. For example, each lid type and/or each lid type criterion can be assigned to the at least one releasable appliance function. This information can be stored in the appliance controller.

The kitchen appliance according to the application may preferably comprise a tool drive configured to drive at least one kitchen appliance tool. The tool drive may in particular be integrated in the appliance base. The tool drive is in particular controllable by an appliance controller of the kitchen appliance. Preferably, the at least one kitchen appliance tool can be detachably coupled to the drive. In particular, the kitchen appliance tool may be arranged in the container arrangement. For example, the kitchen appliance tool may be a cutting tool (e.g., knife) and/or a stirring tool and/or a spatula and/or circulating element and/or covering element.

According to a preferred embodiment of the kitchen appliance according to the application, the kitchen appliance may comprise a tool drive operable (in principle) between a minimum drive parameter value (e.g., 0) and a maximum drive parameter value and configured to operate and drive, respectively, at least one kitchen appliance tool. In particular, a drive parameter setpoint value can be specified by an appliance controller. The appliance controller can be configured to control the tool drive with the drive parameter setpoint value. Then, the tool drive may drive the kitchen appliance tool according to the drive parameter setpoint value. The drive parameter setpoint values may comprise a speed, a direction of rotation and/or a torque.

The kitchen appliance (in particular the appliance controller of the kitchen appliance) may comprise at least one limiting module. The limiting module may be configured to limit and reduce, respectively, at least one maximum allowable drive parameter setpoint value based on the identified lid type and a (predefined) drive criterion for the lid type. The maximum allowable drive parameter setpoint value may be less than the maximum drive parameter value of the tool drive.

This means in particular that depending on the identified lid type, driving the kitchen appliance tool is not permitted respectively possible with the maximum possible drive parameter value of the tool drive, but only with a low drive parameter setpoint value, which is set by the limiting module.

In particular, the drive parameter setpoint value that can be specified by the appliance controller, for example, is limited to a maximum permissible drive parameter setpoint value that is smaller than the drive parameter setpoint value that is possible in principle.

This means that the appliance controller can specify the maximum permissible drive parameter setpoint value as the drive parameter setpoint value and can thus in particular control the tool drive.

The drive criterion can be predefined and in particular define at least the maximum permissible drive parameter setpoint value. A permissible drive parameter setpoint value range can also be defined. A drive criterion can preferably be assigned to each lid type and/or lid type criterion. This data can be stored in a data memory of the kitchen appliance, for example in the form of an assignment table.

By limiting the adjustable drive parameter value depending on the lid type, impermissible operating states of the kitchen appliance can be prevented. This reliably prevents the tool drive from being operated with a drive parameter value that is not permissible for a specific lid type.

Preferably, the at least one drive parameter can be a speed and/or torque and/or direction of rotation. In particular, different speed and/or torque ranges of a tool drive, e.g., in the form of a mixing knife drive, can be released depending on the identified lid type. Alternatively, the heating power as well as the temperature range of the heating could also be released and limited, respectively.

According to a further preferred embodiment, the detection device may be configured to determine at least one inductance value from at least one sensor signal received from a coil. As has been described, this inductance value can be compared with the lid type criteria (such as different predefined inductance value ranges). In a simple and reliable manner, the lid type can be determined by the detection device.

Alternatively or additionally, the detection device may be configured to determine at least one inductance value curve from at least one sensor signal received from a coil (during a movement process of the lid from the first operating position to the second operating position). As has been described, this (temporal) inductance value curve can be compared with the lid type criteria (such as different predefined inductance value curves). In a simple and reliable way, the lid type can be determined by the detection device.

Alternatively or additionally, the detection device can be configured to determine at least one signal pattern (which in particular represents one or more magnetic field directions and pole position combinations, respectively) from at least one sensor signal received from a magnetic field sensor. As has been described, this signal pattern can be compared with the lid type criteria (such as different predefined signal patterns and pole position combination, respectively (cf. Table 2)). In a simple way, the lid type can be determined by the detection device.

Alternatively or additionally, the detection device may be configured to determine at least one signal pattern curve from at least one sensor signal received from a magnetic field sensor (during a movement process of the lid from the first operating position to the second operating position). As has been described, this (temporal) signal pattern curve can be compared with the lid type criteria (such as different predefined signal pattern curves). In a simple and reliable way, the detection device can determine the type of lid.

As has already been described, the lid can be moved manually between a first operating position and a second operating position or moved automatically by a lid drive. According to a further embodiment of the kitchen appliance according to the application, the kitchen appliance (in particular the appliance base) may comprise a lid drive. The lid drive can be configured to move a lid at least between the first operating position and the second operating position.

The detection device may be configured to detect at least one lid drive parameter value. The detection device can be configured to detect the locking state of the container arrangement (additionally) based on the detected lid drive parameter value (and in particular a lid drive criterion). In particular, a lid drive parameter value can additionally be detected and evaluated. The locking state of the container arrangement can be determined based on the detected electrical variable and the lid drive parameter value. Preferably, a lid arranged in the second operating position (and a corresponding state, respectively) is only detected if both the detected electrical variable fulfils the position criterion and the detected lid drive parameter value fulfils the (predefined) lid drive criterion. The second operating state, such as a locking state, can be determined in an even more reliable manner.

In particular with the automatic movement mechanism preferably in the form of a locking mechanism with a lid drive, it is advantageous to use a mechanical detection path in addition to the described magnetic field-based detection of the lid and the locking state, respectively. Advantageously, the movement of the drive elements of the lid drive used for moving, in particular for closing respectively locking the lid, can be detected and evaluated. Based on the evaluation, the presence and the (correct) positioning, in particular locking, of the lid can be concluded. Due to the resulting redundancy, monitoring and/or fault diagnosis of both detection paths is possible. This can further improve the security.

In a preferred embodiment, the lid can be moved relative to the food receiving element during closing respectively locking. In particular, moving the lid also comprises moving only a part of the lid. For example, a lid can be bayonetted and thus in particular locked by a rotary movement. Depending on whether a lid is fitted or not, the lid drive reaches different end positions. In order to determine these, the position and/or the actuator current can be detected in particular as the lid drive parameter.

The respective detection results can be checked for plausibility against each other by comparing them with the detected sensor signal, in particular the first sensor datum. In particular, it can be checked whether the end position of the lid drive is reached in the same time window respectively position window within which the detection device has also detected the first sensor datum that represents the second operating state, such as the “lid locked” state and the locking state, respectively. Preferably, only if both detection results match in time, i.e., are detected in the same time window, the lid can be assessed as (actually correctly) positioned, in particular locked. This makes manipulation more difficult and allows the correct function of the detection device to be checked during operation.

A still further aspect of the application is a method of determining and detecting, respectively, a second operating state (and the second operating position of the lid, respectively) in a previously described container arrangement. The method comprises:
receiving, by a detection device, a first sensor datum output by the magnetic field-based sensor element, and
detecting, by the detecting device, the second operating state of the container arrangement based on the detected first sensor datum and at least one position criterion.

In particular, the detection device may be a previously described detection device. Preferably, an appliance base of a previously described kitchen appliance may comprise the detection device. In variants of the application, the container arrangement may also comprise the detection device.

In particular, the method may be used to determine a locking state in a previously described container arrangement of a previously described kitchen appliance. Preferably, the method may further be used to identify the type of lid as previously described.

A module, device or the like can be at least partially realized by hardware elements and/or software elements. In principle, data can be transmitted immediately or first collected and temporarily stored in order to be transmitted together at certain times, for example. Furthermore, terms such as “top”, “upper”, “bottom”, “lower”, etc., refer to the direction running vertically to a horizontal plane and to a container arrangement and/or kitchen appliance placed on a horizontal surface. Unless otherwise stated, expressions such as “first”, “second”, etc. are used only to distinguish two elements and do not indicate an order.

The features of the container arrangements, kitchen appliances and methods can be freely combined with each other. In particular, features of the description and/or the dependent claims may be independently inventive, even by completely or partially circumventing features of the independent claims, alone or freely combined with each other.

### BRIEF DESCRIPTION OF THE DRAWINGS

There are now a multitude of possibilities for designing and further developing the container arrangement according to the application, the kitchen appliance according to the application and the method according to the application. In this regard, reference is made on the one hand to the patent claims subordinate to the independent patent claims, and on the other hand to the description of embodiments in connection with the drawing. The drawing shows:

FIG. 1 a schematic view of an embodiment of a container arrangement according to the present application,

FIGS. 2a to 2c schematic views of an embodiment of a kitchen appliance according to the present application,

FIG. 3a a schematic view of a further embodiment of a container arrangement according to the present application,

FIG. 3b a schematic view of an embodiment of a coil according to the present application,

FIG. 4 a diagram of an exemplary inductance value curve,

FIG. 5 a schematic view of a further embodiment of a kitchen appliance according to the present application,

FIG. 6a a schematic top view of a further embodiment of a container arrangement according to the present application,

FIG. 6b schematic views of the container arrangement according to FIG. 6a in various lid states and with an exemplary inductance value curve,

FIG. 7 a schematic view of a further embodiment of a kitchen appliance according to the present application,

FIG. 8 a schematic view of a further embodiment of a kitchen appliance according to the present application,

FIG. 9 a schematic view of a further embodiment of a kitchen appliance according to the present application,

FIG. 10 schematic views of an embodiment of a container arrangement according to the present application in different lid states and an exemplary induction value curve,

FIG. 11 a schematic view of a further embodiment of a kitchen appliance according to the present application,

FIG. 12 different exemplary states in an embodiment of a kitchen appliance according to the present application with a lid drive,

FIG. 13 exemplified signal curves in an embodiment of a kitchen appliance according to the present application with a lid drive,

FIG. 14 further exemplary signal curves in an embodiment of a kitchen appliance according to the present application with a lid drive, and

FIG. 15 a diagram of an embodiment of a method according to the present application.

### DESCRIPTION OF THE INVENTION

In the following, similar reference signs are used for similar elements.

In particular, the following embodiments are based on a pot as the food receiving element. It shall be understood that the embodiments can be transferred to other food receiving elements. Furthermore, in the following embodiments, an unlocked position is assumed as a first operating position, a locking position is assumed as a second operating position, a locking criterion is assumed as a position criterion, and a locked state is assumed as a second operating state. Again, the examples can be easily transferred to other operating positions and/or operating states.

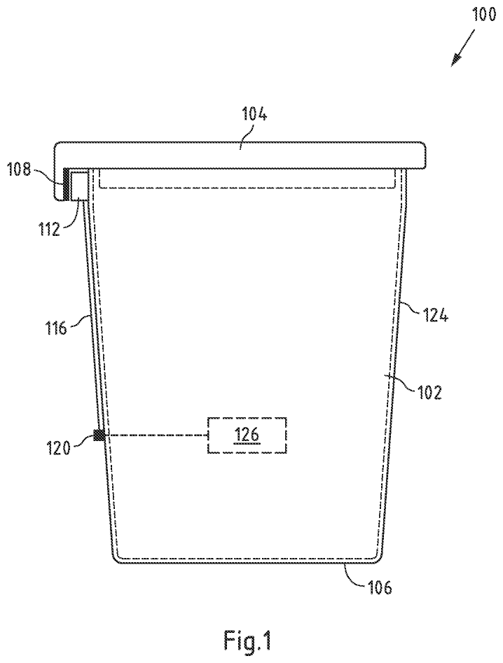

FIG. 1 shows a schematic view of an embodiment of a container arrangement 100 according to the present application for a kitchen appliance, in particular a food processor configured for at least partially automated preparation of food. The depicted container arrangement 100 comprises a pot 102 and at least a first lid 104. The pot 102 has a circumferential pot wall 124 and a pot bottom 106.

The lid 104 is configured to close an opening of the pot 102. This closed state of the container arrangement 100 is shown in FIG. 1. In particular, the first lid 104 is in the locking position in FIG. 1. This means that the first lid 104 is (correctly) mechanically locked to the pot 102, i.e., the container arrangement 100 is in the locking state.

The lid 104 is movable relative to the pot 102, in particular between an unlocked position and the locking position. The locking mechanism may be, for example, a bayonet locking or similar mechanical locking.

As can further be seen, the lid 104 comprises at least a first magnetic field-based counter element 108. The pot 102 comprises at least one magnetic field-based sensor element 112 connectable to a detection device 126. As shown, for example, a wired-based connection 116 may be provided between the sensor element 112 and a lower pot contact 120. The detection device 126 may be connected to the lower pot contact 120.

The detection device 126 is configured to detect a locked state of the lid 104 based on a first sensor datum, as will be described in further detail. For example, the pot 102 may comprise the detection device 126, as indicated by the dashed lines in FIG. 1.

The magnetic field-based sensor element 112 is configured to output the first sensor datum only upon detection of the first magnetic field-based counter element 108 in the detection range of the magnetic field-based sensor element 112. The at least one first magnetic field-based counter element 108 is arranged in respectively on the lid 104 (and in particular relative to the sensor element 112 of the pot 102) such that the magnetic field-based counter element 108 is only respectively can only enter the detection range of the magnetic field-based sensor element 112 when the lid 102 is in the locking position.

In other words, a magnetic field change leading to respectively representing the output of the first sensor datum can only be detected by the magnetic field-based sensor element 112 if the lid 104 is in the locking position such that the counter element 108 is within the detection range of the sensor element 112.

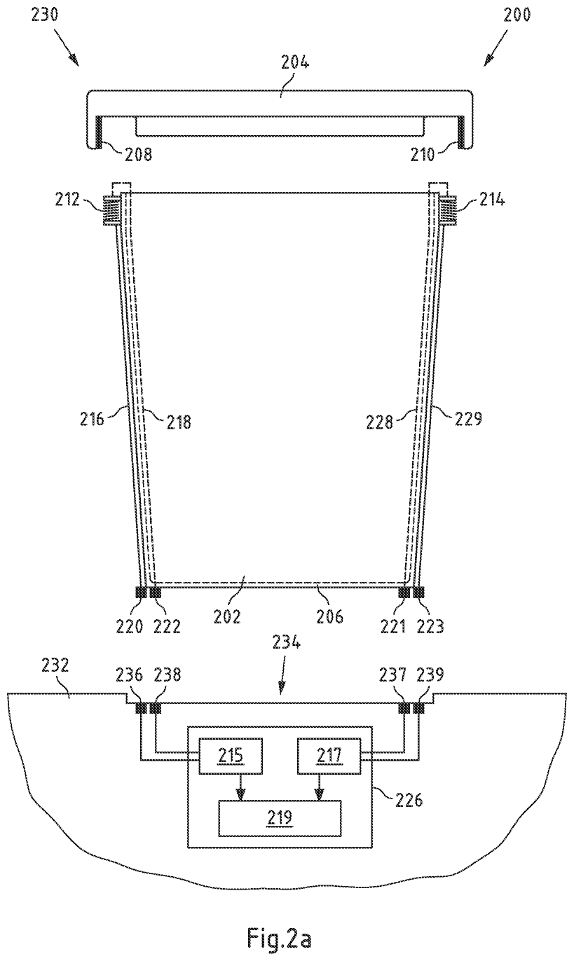

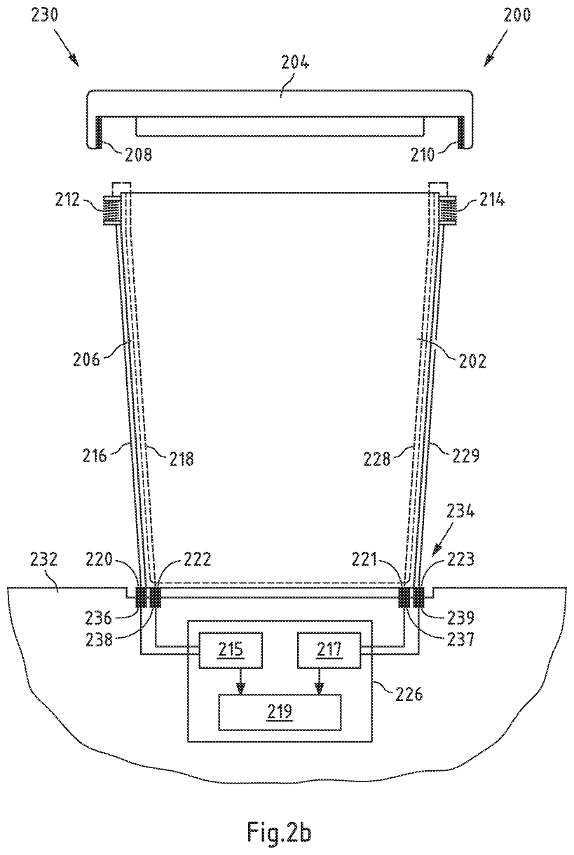

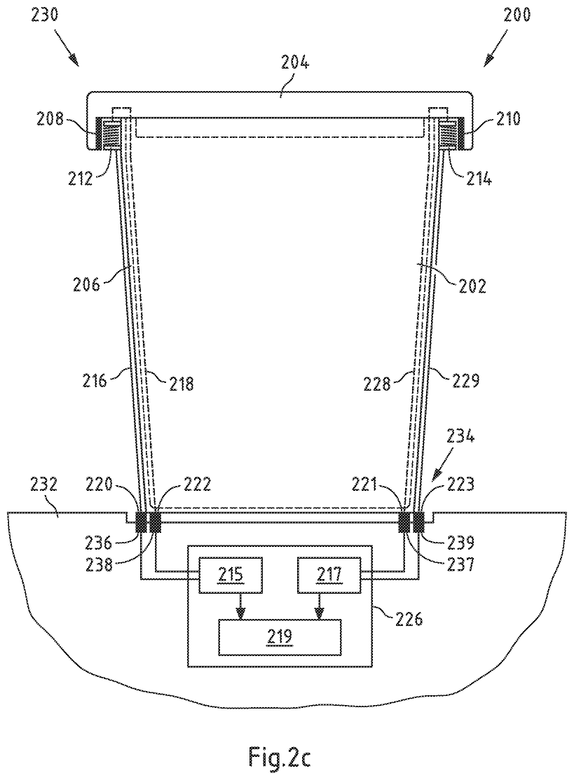

FIGS. 2a to 2c show schematic views of an embodiment of a kitchen appliance 230 according to the present application, in particular with a container arrangement 200. In FIG. 2a, the pot 202 is not arranged in a pot receptacle 234 of an appliance base 232 of the kitchen appliance 230 and the lid 204 is not placed on the pot 202. In FIG. 2b, the pot 202 is arranged in the pot receptacle 234 of the appliance base 232 of the kitchen appliance 230 and the lid 204 is not placed on the pot 202. In FIG. 2c, the pot 202 is arranged in the pot receptacle 234 of the appliance base 232 of the kitchen appliance 230 and the lid 204 is placed on the pot 202 (in particular, it is in the locking position).

The magnetic field-based detection concept implemented in the present case is in particular an induction-based concept. Presently, the pot 202 comprises two coils 212, 214 as magnetic field-based sensor elements 212, 214. In other variants of the application, a different number of coils may be provided.

As can be seen, the coils 212, 214 are arranged on the upper edge of the pot (which forms the opening of the pot 202) and in particular on substantially opposite sides of the edge of the pot.

A first coil contact of the first coil 212 is connected to a first lower pot contact 220 via a first electrical pot connection 216. A second coil contact of the first coil 212 is connected to a first lower pot contact 222 via a second electrical pot connection 218. A first coil contact of the second coil 214 is further connected to a third lower pot contact 221 via a third electrical pot connection 228. Finally, a second coil contact of the second coil 214 is connected to a fourth lower pot contact 223 via a fourth electrical pot connection 229. In particular, the number and position of the lower pot contacts 220, 221, 222, 223 at the pot bottom corresponds to the number and position of the base contacts 236, 237, 238, 239 of the appliance base 232. This allows electrical connection of the lower pot contacts 220, 221, 222, 223 to a detection device integrated in the appliance base 232 when the pot 202 is (properly) positioned in the pot receptacle 234. The pot receptacle 234 is configured to receive the pot 202, in particular at least the pot bottom 206.

The at least one magnetic field-based counter element 208, 210 (exemplarily two are shown in the present case) is in particular an induction element 208, 210 formed from an inductance-influencing material. Preferably, an induction element 208, 210 can be a flat element 208, 210 which is in particular made of a soft-magnetized metal or a non-magnetic metal.

Preferably, the induction elements 208, 210 (analogous to the coils 212, 214) may be arranged on the lid edge and in particular on substantially opposite lid edge sides.

Only in the locking state of the lid 204 (cf. FIG. 2c) the induction elements 208, 210 enter the respective detection range of the coils 212, 214. Only in this case the magnetic field generated by the respective coil 212, 214 is influenced by the respective induction element 208, 210. This results in a changed induction value of the respective coil 212, 214. This can be output by the coil 212 as a first sensor datum and in particular be detectable by the detection device 226.

As described above, in the present case, the appliance base 232 comprises a detection device 226 electrically coupled to the base contacts 236 to 239. In particular, the detection device 226 may be integrated in the appliance controller of the kitchen appliance 230. In variants of the application, the detection device may also be integrated in the pot. For example, the detection device may be integrated in the pot if the pot is equipped with a smart interface and a corresponding (small) controller is integrated in the pot.

The detection device 226 is configured to detect and determine, respectively, the locking state based on the at least one first sensor datum and in particular a locking criterion. If the detected sensor signal respectively the first sensor datum contained therein fulfils the locking criterion (for example a predefined electrical variable range, preferably an induction value range), then the detection device 226 can detect and determine, respectively, the locking state. If not met, the unlocked state may be detected and determined, respectively, by the detection device 226.

Preferably, a first induction value of the first coil 212 can be determined, in particular measured, by a first measuring module 215 of the detection device 226. The first electrical measuring module 215 of the detection device 226 can in particular apply a first electrical variable (e.g., a current respectively a voltage) to the coil 212 and measure a resulting electrical variable (a voltage respectively a current). From the variables of current and voltage, the detection device 226 may determine the inductance value of the first coil 212. In a corresponding manner, the induction value of the second coil 214 can be determined, for example, by a further measuring module 217 of the detection device 226.

The determined induction values can be provided to an evaluation module 219 of the detection device 226. The evaluation module 219 can in particular compare the induction values with at least one locking criterion in the manner described above. If the at least one locking criterion is met, a locking state of the lid can be concluded.

The at least one locking criterion may, for example, specify a range of induction values at which the locking state is present. By comparing the determined induction values with the predefined induction value range, the detection device 226 can detect and determine, respectively, whether the locking criterion is fulfilled or not, i.e., whether a locking state is present or not.

Preferably, the at least one appliance function of the kitchen appliance 230 can only be released by the detection device 226 when a locking state is detected. If an unlocked state is detected, the at least one appliance function can remain locked and blocked, respectively.

If the pot 202, as shown in FIG. 2a, is not on the appliance base 232, the electrical contacts 220 to 223 respectively 236 to 239 are open. In particular, the appliance controller (not shown) of the appliance base 232 can detect that no pot 202 is fitted.

In FIG. 2b, the pot 202 is on the appliance base 232 so that the electrical connection to the coils 212, 214 is given. However, the lid 204 is not in place respectively in the defined locking position. The respective inductance value of the coils 212, 214 is thus unaffected and corresponds to the initial value. By evaluating the inductance values by the detection device 226, it can be detected that the lid 204 is not locked and an unlocked state is present.

If the lid 204 is in the locking position, as shown in FIG. 2c, the inductance values of the respective coils 212, 214 are affected. This can be detected with the help of the described inductance measurement. By evaluating the inductance values, the locking state of the lid 204 can thus be determined. Based on this information, specific device functions can then be released, e.g., the movement of a shredding tool.

The use of several coils 212, 214 at different points on the circumference of the pot has the advantage that the position of the lid 204 is detected at two points so that it can also be detected if the lid 204 is incorrectly placed on only one side and is therefore not correctly locked.

As has already been described, preferably not only the locking state can be detected, but also the lid type of the lid 204 locked to the pot 202. As the number of sensor elements 212, 214 increases, the number of different, uniquely identifiable lid types can also be increased.

In this embodiment, two coils 212, 214 are attached to the upper edge of the pot, whose (instantaneous) inductances and inductance values, respectively, can be measured independently from each other. The lid 204 can preferably be closed (i.e., moved into the locking position) by a rotary movement and, in particular, bayonetted (locked) in the process. Metal plates 208, 210, for example, are attached to the lid 204 as inductance-influencing induction elements 208, 210. As has already been described, these elements 208, 210 are arranged in such a way that they are only directly in the detection range of the coils 212, 214 if the lid 204 is (correctly) locked.

Depending on the chosen material, the metal plates increase or decrease the inductance of the coil. For example, the inductance increases with a soft magnetic metal plate (cf. reference sign 445 in FIG. 4), as this reduces the magnetic resistance of the coil. With a metal plate made of non-magnetic, electrically conductive material (cf. reference sign 447 in FIG. 4), on the other hand, the eddy current effect dominates and the inductance value of the coil decreases. At X1 the lid is open, while at X2 the lid is locked. L1 and L2 denote the coil inductances.

Different combinations of metal plate materials on the left and right side of the lid 204 as induction elements 1 and 2 (cf. explanations on Table 1) can be used to uniquely code different lid types. This coding table may be stored as lid type criteria in the detection device 226. Depending on whether both inductances increase, both decrease or induction element 1 and 2 experience different changes in the locking state, the respective lid type can be concluded.

In the shown example with two coils 212, 214, four lid types can be reliably distinguished by evaluating the inductance values, in particular the inductance value curves respectively the change directions of the inductances. In principle, it is also possible to obtain intermediate values of the inductance of a coil by selecting the material or shaping the metal plates 208, 210 and thus to further increase the number of distinguishable lid types, as has already been described.

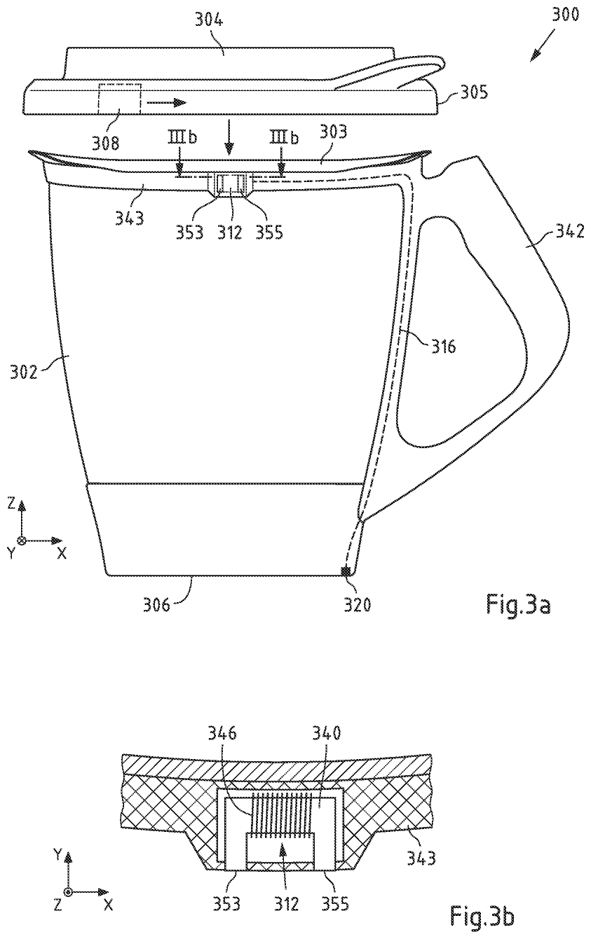

FIG. 3 shows a schematic side view of an embodiment of a container arrangement 300 according to the present application.

The pot 302 is preferably formed partly of metal and partly of plastic. In particular, a portion 342 may be formed of plastic. This portion 342 may also form the handle and comprise an at least partially, preferably completely, circumferential sub-portion 343 arranged on the edge 303 of the pot.

A first coil 312 is arranged at the upper pot edge 303. Preferably, a (not shown) second coil is arranged on the opposite side of the upper pot edge 303. The at least two electrical pot connections 316 extend from the respective coil 312, in particular through the section 342 to the at least two lower pot contacts 320. In particular, a pot connection 316 may be integrated in the plastic section 342. In particular, the at least two lower pot contacts 320 are arranged in respectively on the pot bottom 306.

The coils 312, are preferably embedded in the circumferential partial section 343 made of plastic and are preferably at least partially covered by a pot cover 344, in particular in the form of an aperture 344. The partial section 343 preferably comprises a part of the locking mechanism. In particular, the partial portion 343 may have contours for locking the lid 304 to the pot 302 in the defined locking position.

As shown in FIG. 3b, a coil 312 can preferably be formed from a yoke 340 and coil core 340, respectively. The yoke 340 is in particular a U-shaped yoke 340 which can be designed e.g., as a U-shaped bent sheet of soft magnetic material.

The coil winding 346 in particular is arranged around this yoke 340. As has already been described, a coil 312 can preferably be covered by a plastic aperture 344. The ends 353, 355 of the yoke 340 can in particular protrude through recesses and openings, respectively, in the aperture 344.

As can be seen in FIG. 3a, the induction elements 308 are arranged on the lid 304, in particular on the outer lid edge 305. As can be seen, the induction elements 308, 310 can be formed as flat elements 308, 310, in particular by metal plates 308, 310. Only by way of example the shown flat elements 308, 310 comprise a rectangular shape.

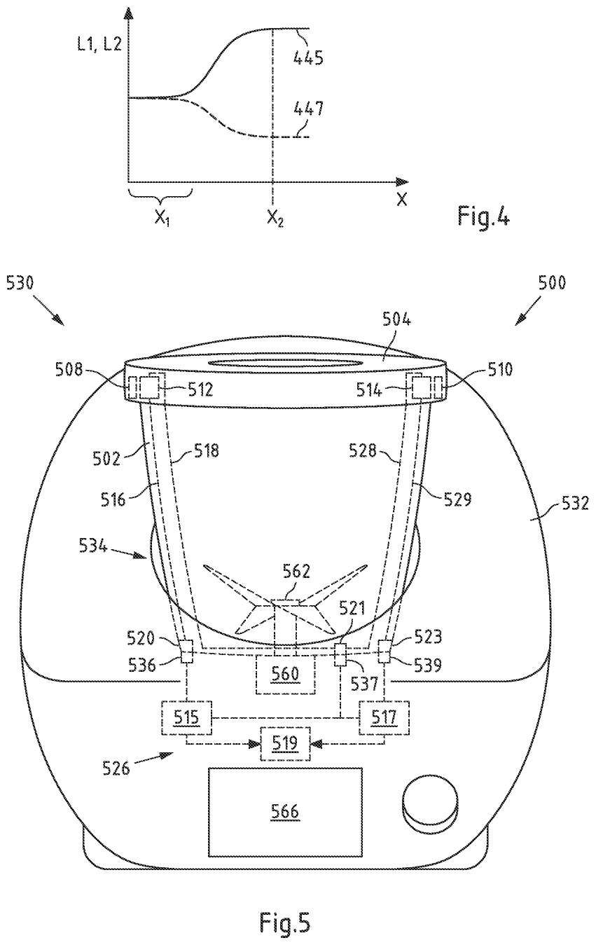

FIG. 5 shows a schematic view of a further embodiment of the kitchen appliance 530 according to the application. In order to avoid repetitions, essentially only the differences to the previous embodiments are described below and otherwise reference is made to the respective embodiments.

In particular, as can be seen in FIG. 5, in the present embodiment, the coils 512, 514 comprise a common third lower pot contact 521 which is connected to the detection device 526 of the appliance base 532. The other two coil contacts may each be separately routed to the detection device 526 of the appliance base 532. This has the advantage that the coils 512, 514 can be evaluated individually by a corresponding detection device 526 so that inductance curves can be clearly assigned to the individual coils 512, 514. In particular, the number of contacts can be reduced at the same time.

As can be seen, the appliance base 532 comprises a tool drive 560. The tool drive 560 is configured to drive and operate, respectively, a kitchen appliance tool 562, which may in particular be located in the pot 502. Exemplarily, a kitchen appliance tool 562 is shown as a cutting tool 562. Further, the kitchen base may comprise a control device that controls and monitors the heater that is integrated in the pot 502.

It may be provided that the kitchen appliance tool 562 must be operated with different maximum permissible drive parameter setpoint values depending on the lid type of the currently attached lid 504. In order to ensure this, the detection device 526 may preferably comprise a limiting module. The (not shown) limiting module may be configured to limit at least the maximum permissible drive parameter setpoint value, based on the identified lid type and a drive criterion (predefined) for the lid type. Each lid type may have a predefined drive criterion associated with it. The drive criterion may define the maximum permissible drive parameter setpoint value or a corresponding range.

Optionally, the kitchen appliance 530 may have a (visual) display 566. The display 566 may be configured to display the identified lid type. Optionally, an error message and/or an advisory message may be displayed.

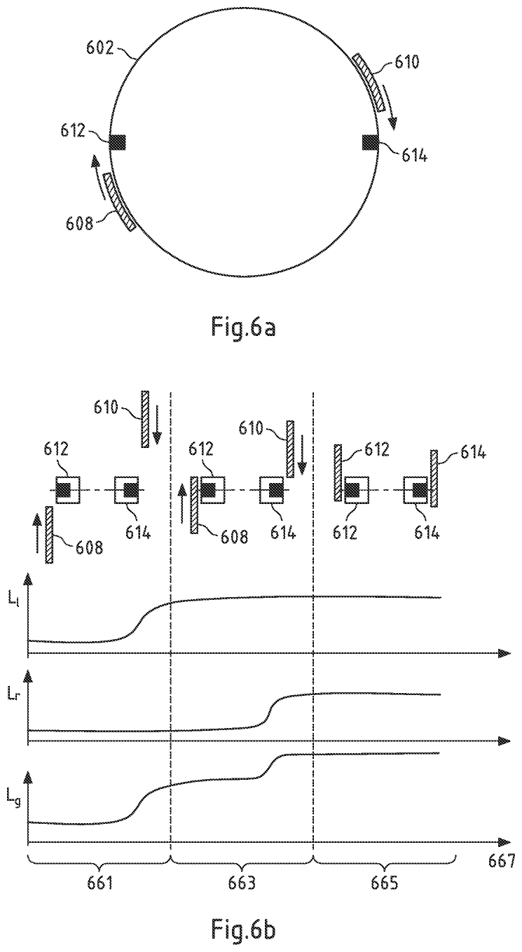

A further (additional) possibility to reliably distinguish and, in particular, identify different lid types is to measure the inductance versus the locking path that has to be covered from the unlocked position to the locking position. This can be done, for example, by shaping and/or defining the arrangement of the induction elements 608, 610. This is illustrated by way of example in FIGS. 6a, 6b.

Lₗ is the inductance curve of the left inductance (formed by elements 608, 612), Lᵣ is the inductance curve of the right inductance (formed by elements 610, 614) and L_{g} is the curve of the total inductance (L_{g}=Lₗ+Lᵣ). During the closing movement, i.e. the movement of the lid (not shown explicitly for a better overview) from the unlocked position (designated by the reference sign 661; see also left section of FIG. 6b) to the locking position (designated by the reference sign 665; see also right section of FIG. 6b), which can correspond in particular to a rotation of the lid, the inductance value curve of both coils 612, 614 respectively left coil 612 and right coil 614 can be evaluated. The reference sign 667 indicates the position of the lid and the reference sign 663 indicates the intermediate position of the lid during the closing process.

Depending on the arrangement and/or shape of the induction elements 608, 610, different temporal inductance value curves result, which are shown as examples in the diagrams. By analyzing the curves of the inductance values of the individual inductances and/or the total inductance, it is then possible to conclude the respective lid type. For this purpose, corresponding inductance value curves can in particular be predefined as lid type criteria and can in particular be stored in the detection device. Particularly preferred in this embodiment are automatic lockings/locking types with a (large) path (e.g., bayonet). This increases the reliability of the detection.

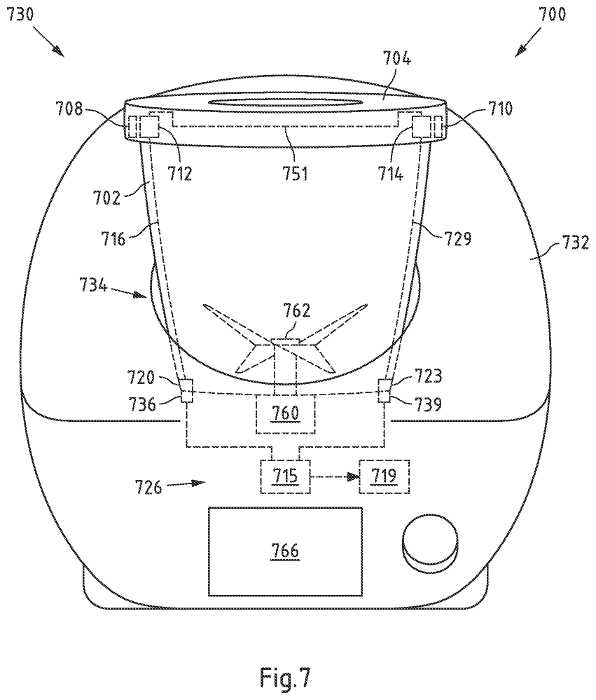

FIG. 7 shows a schematic view of a further embodiment of the kitchen appliance 730 according to the application. In order to avoid repetitions, essentially only the differences to the previous embodiments are described below and otherwise reference is made to the corresponding embodiments.

In this embodiment, the coils 712, 714 are connected in series via a fifth pot connection 751. With such an arrangement, an evaluation of the sum inductance, as illustrated in FIG. 6b, is particularly advantageous.

The series connection of the coils 712, 714 offers in particular the possibility of getting by with only two contacts 720, 723, 736, 739 each to the appliance base 732. If the induction elements 708, 710 are arranged in such a way that if the lid 704 is closed, first the coil 712 and then additionally also the further coil 714 are influenced, then the inductance of the series connection increases in two stages (cf. FIG. 6b). By evaluating the temporal curve of the total inductance (sum inductance), it can then be checked whether the lid 704 is in the correct position on both sides, i.e., in the locking position.

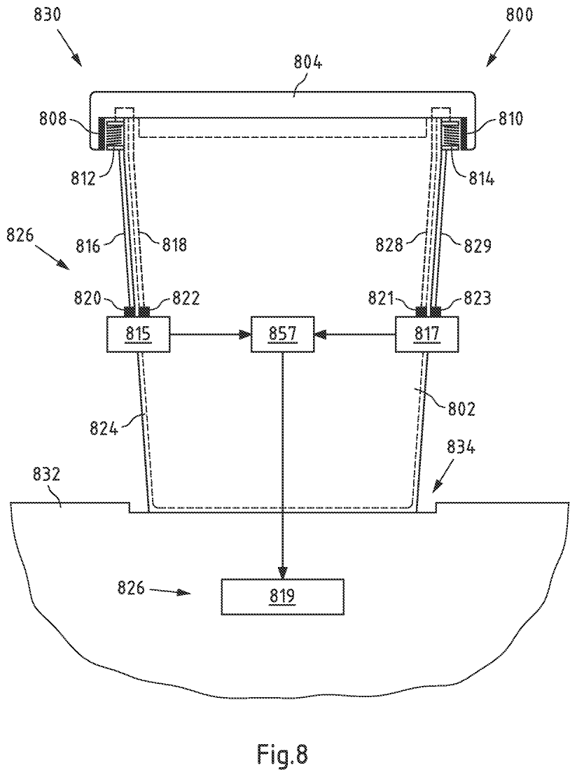

FIG. 8 shows a schematic view of a further embodiment of the kitchen appliance 830 according to the application. In order to avoid repetitions, essentially only the differences to the previous embodiments are described below and otherwise reference is made to the corresponding embodiments.

As described above, the container arrangement 800 may at least partially comprise the detection device 826. In the present case, the container arrangement 800 comprises the first and the second measuring module 815, 817. A (digital) communication module 857 of the detection device 826 can be configured to transmit the measured induction values to an evaluation module 819. In the present case, the evaluation module 819 is integrated in the appliance base 832, in particular in the appliance controller. In variants of the application, the container arrangement 800 may also comprise the evaluation module.

As has been described, an evaluation of the measured values can also be carried out at the pot 802 so that, for example, the locking state and the lid type can be determined and transmitted in digital form.

It is also possible, for example, to store calibration data for the inductances in electronics (e.g., microcontroller) integrated in the pot 802. Other measured values from the pot 802 can also be transmitted in this way so that an overall reduction in the number of contacts is possible.

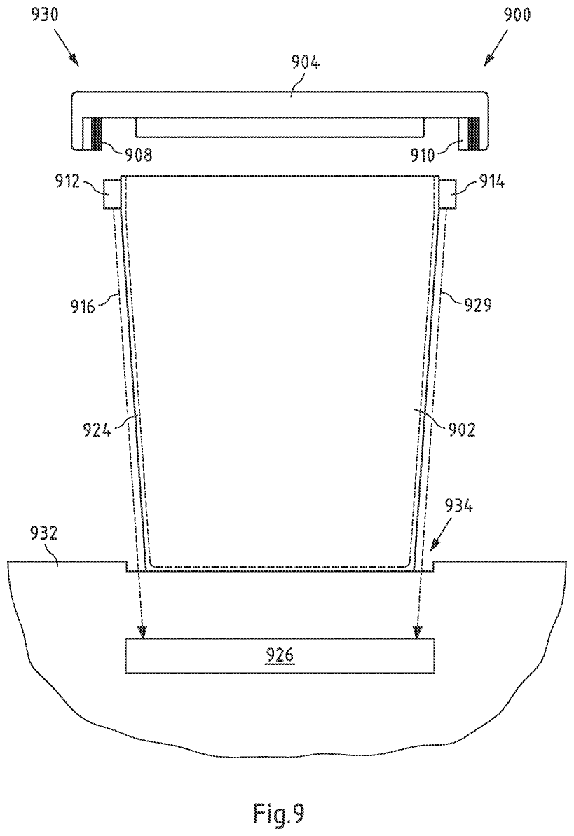

FIG. 9 shows a schematic view of a further embodiment of the kitchen appliance 930 according to the application. In order to avoid repetitions, essentially only the differences from the previous embodiments are described below and otherwise reference is made to the corresponding embodiments.

The main difference is that a magnetic field sensor is used instead of a coil and a magnet instead of an induction element.

Thus, in this embodiment, the at least one magnetic field-based sensor element 912, 914 (exemplarily two sensor elements 912, 914 are shown herein) is a magnetic field sensor 912, 914. Preferably, a magnetic field sensor 912, 914 may be a Hall sensor 912, 914 or a reed switch 912, 914. The arrangement of the magnetic field sensors 912, 914 at the pot 902 can be similar to the arrangement of the coils at a pot described above.

Furthermore, at least one magnet 908, 910 (in the present example, two magnets 908, 910 are provided) is provided as a magnet-based counter element 908, 910 in the present embodiment. The arrangement of the magnets 908, 910 at the lid 904 can be similar to the arrangement of the induction elements at a lid described above.

When the lid 904 is moved into the locking position, the at least one magnet 908, 910 enters the detection range of the at least one magnetic field sensor 912, 914. The magnetic field change can be detected by the magnetic field sensor 912, 914. In response to this, the magnetic field sensor 912, 914 outputs the first sensor datum.

Since the at least one magnet 908, 910 is arranged at the lid 904 in such a way that a detectable magnetic field change leading to an output of the first sensor datum can only be present if the lid 904 is in the locking position, a locking state of the lid 904 can be reliably detected by detecting the first sensor datum.

As can be seen, each magnetic field sensor 912, 914 is connected to the detection device 926, in particular to provide at least the first sensor datum for evaluation. The evaluation can be carried out similarly to the previous embodiments.

The encoder magnets 908, 910 arranged at the lid 904 and corresponding to the magnetic field sensor 912, 914 trigger in particular, as has been described, a detection signal and the first sensor datum, respectively, in the magnetic field sensors 912, 914 when the lid 904 is closed and correctly locked. A detection and identification, respectively, of the lid type is also possible here, e.g., if magnetic field sensors 912, 914 are used which allow an evaluation of the magnetic field direction of the magnet 908, 910 located in the detection range. Depending on the orientation of the magnetic poles, a characteristic signal pattern then results for the different lid types. In the example shown in FIG. 9, it is possible to identify a specific lid type in particular by using Table 2, as already described.

It is also possible, in further variants of the application, that a counter element in the form of an encoder magnet is arranged on the pot and a conductive element is arranged in the lid merely as a further counter element, which conducts the magnetic field (in a defined manner) through respectively to the associated magnetic field sensor if the lid is (correctly) locked.

The arrangement of the detection device 926 for a magnetic field sensor 912, 914 can be similar to inductive detection in the pot or in the base of the appliance. Furthermore, it is conceivable that by placing several magnets, the signal curve during closing is also analyzed so that a more reliable detection can take place.

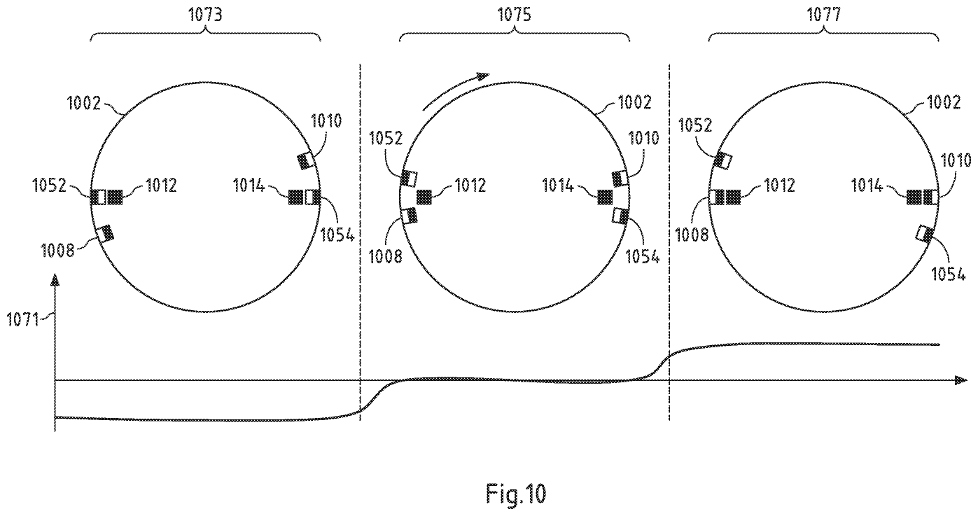

FIG. 10 shows schematic views of an embodiment of a container arrangement according to the present application in various lid states and an exemplary induction value curve 1071 and signal curve, respectively, of the sensors 1071.

The container arrangement may be formed similarly to a container arrangement in any of the previous Figures. The main differences between the container arrangement and the previous embodiments are described below.

In particular, the illustrated lid comprises first counter elements 1008, 1010 and additional counter elements 1052, 1054.

For example, the first counter elements 1008, 1010 may be magnets 1008, 1010 having a first pole orientation and the additional counter elements 1052, 1054 may be additional magnets 1052, 1054 having a second pole orientation different from the first pole orientation.

The additional magnets 1052, 1054 are arranged on the lid, in particular on the edge of the lid, in such a way that the magnetic field sensors 1012, 1014 are only influenced in the unlocked position, as shown in the left section of FIG. 10.

By evaluating the sensor signal curve 1071 shown in the lower section of FIG. 10, it can be determined at least whether the lid is in the (defined) unlocked position (designated by the reference sign 1073) or the lid 1010 is in the defined locking position (designated by the reference sign 1077). The position in between, i.e., in particular during the locking movement, is designated by the reference sign 1075.

This is shown in the exemplary sensor signal curve in the lower section of FIG. 10. In the unlocked position 1073, a first sensor signal curve can be determined by the detection device (in particular as long as said additional magnets 1052, 1054 are within the detection range of the respective magnetic field sensors 1012, 1014.

During the (rotational) movement 1075 of the lid from the unlocked position to the locking position (middle section of FIG. 10), no magnet 1008, 1010, 1052, 1054 is in a detection range of the magnetic field sensors 1012, 1014. Therefore, the signal takes a value of zero.

When the locking position 1077 is reached (right section of FIG. 10), the magnets 1008, 1010 enter the respective detection range of the magnetic field sensors 1012, 1014. In this locking position, a different sensor signal curve is detected by the detection device due to the different pole orientation (in particular as long as the magnets 1008, 1010 are present in the respective detection range of the magnetic field sensors 1012, 1014, i.e., the lid is in the locking position).

In a simple and reliable way, a locked lid position can be distinguished from the unlocked lid position.

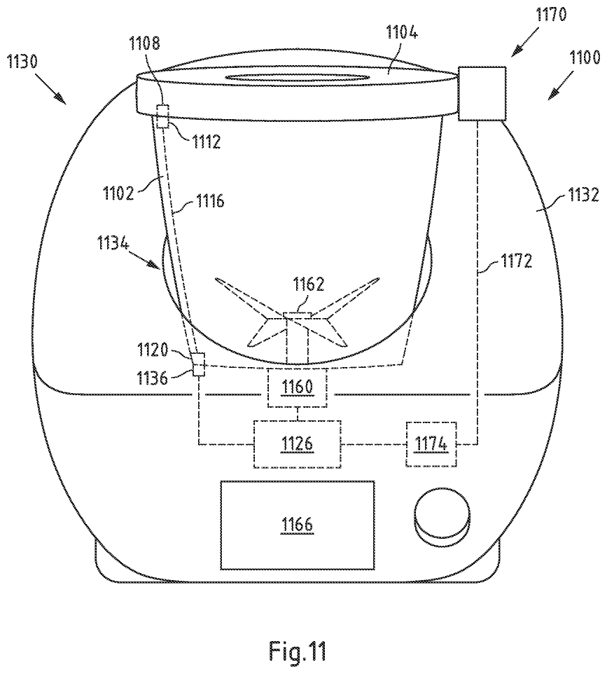

FIG. 11 shows a schematic view of a further embodiment of a kitchen appliance 1130 according to the present application. In order to avoid repetitions, only the differences to the previous embodiments are described below and otherwise reference is made to the corresponding embodiments.

The kitchen appliance 1130 comprises a mechanical locking mechanism 1170 having a lid drive 1174 (also called a locking actuator). The lid actuator 1174 is mechanically coupled to the lid 1104 via a mechanical linkage 1172, which is generally known. The lid actuator 1174 may be configured to (automatically) move the lid 1104 between an unlocked position of the lid 1104 and a locking position of the lid 1104.

The detection device 1126 may be communicatively coupled to the lid drive 1174. In particular, the detection device 1126 may be configured to detect, preferably measure, at least one lid drive parameter value (e.g., position and/or actuator current). The detection device 1126 may further be configured to detect the locking state of the container arrangement 1100 based on the detected lid drive parameter value.

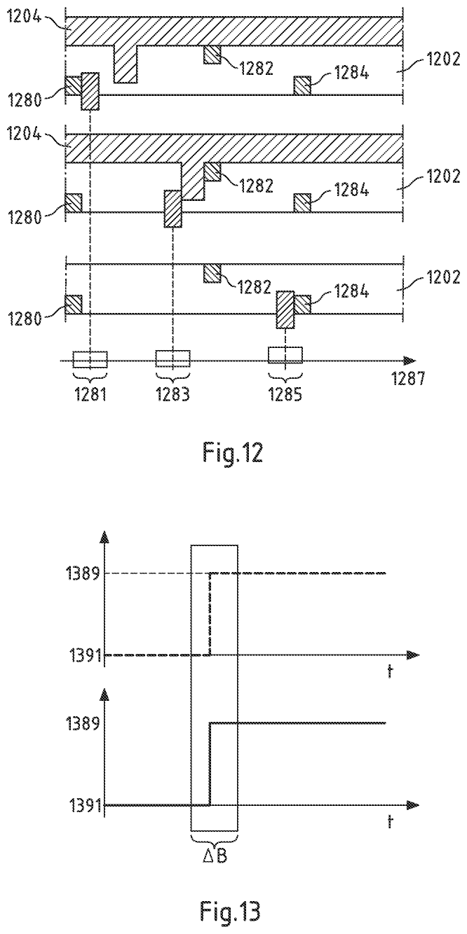

A possible implementation of this detection is graphically illustrated in FIG. 12. The lid 1204 or parts of the lid 1204 can be moved relative to the pot 1202 during closing respectively locking, for example bayonetted by a rotational movement. Depending on whether a lid 1204 is fitted (cf. the two upper sections of FIG. 12) or not (cf. the lower section of FIG. 12), the lid drive reaches different end positions 1280, 1282, 1284, which can be evaluated and in particular determined, for example, by measurement, by the detection device, of position and actuator current.

In the upper section of FIG. 12, the lid 1204 is not locked. The locking movement starts at the end position 1280, in particular in the unlocked position. In the middle section of FIG. 12, a lid 1204 is present. The lid 1204 has been moved to the second end position 1282. The lid 1204 is therefore in the locking state and in the locking position, respectively. There is no lid in the lower section of FIG. 12. The lid drive reaches the third end position 1284. From this, the detection device can conclude that no lid is present.

Reference sign 1287 indicates the axis as the position of the lid drive. Reference sign 1281 indicates the unlocked position, reference sign 1283 indicates the locking position, and reference sign 1285 indicates that there is no lid.

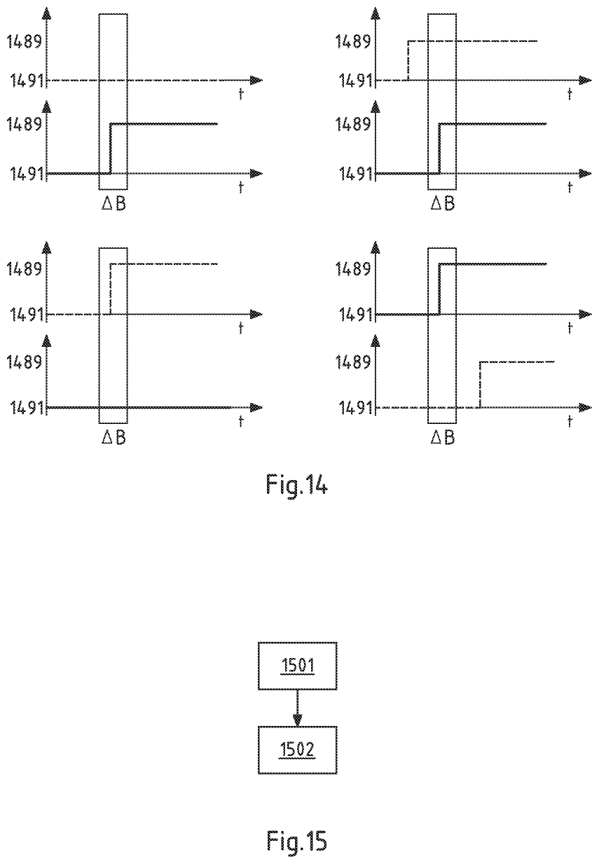

Preferably, the detection device can additionally perform a comparison of the detected time-dependent and/or position-dependent electrical signals and mechanical signals. This is illustrated in more detail in FIGS. 13 and 14. The reference sign 1389 (respectively 1489) indicates the locking state and the reference sign 1391 (respectively 1491) indicates the unlocked state.

FIG. 13 shows in particular the case in which the lid was (correctly) locked. In particular, it can be seen that a locking state was determined almost simultaneously by the detection device by evaluating the at least one sensor signal and first sensor datum, respectively, (as described) (upper section of FIG. 13) and the at least one lid drive parameter (as described) (lower section of FIG. 13). Sufficient simultaneity exists in particular if the respective change of state is detected within a predefined time window ΔB and tolerance range ΔB, respectively.

In particular, a lid can only be evaluated as (correctly) locked by the detection device, i.e., a locked state can only be determined, if the signals of both detection paths change from the state “unlocked” to the state “locked” within the tolerance range ΔB (cf. FIG. 13).

FIG. 14 shows four exemplary signal sequences in which a lid is assessed by the detection device as not (correctly) locked, i.e., an unlocked state is determined. As can be seen, in none of the cases shown does the “unlocked” state change to the “locked” state within the predefined time period.

FIG. 15 shows a diagram of an embodiment of a method according to the present application for determining a locking state in a container arrangement according to any of the previous embodiments.

In a first step 1501, a receiving of a first sensor datum output by the magnetic field-based sensor element is performed by a detection device, as described above.

In a further step 1502, a detecting, by the detecting device, a locking state of the container arrangement is performed based on the detected first sensor datum and at least one locking criterion as described above.

### LIST OF REFERENCE SIGNS

100, 200, 300, 500, 700, 800, 900, 1100 container arrangement
102, 202, 302, 502, 602, 702, 802, 902, 1002, 1102 pot
303 upper edge
104, 204, 304, 504, 704, 804, 904, 1104 lid
305 lid edge
106, 206, 306 bottom
108, 208, 308, 508, 608, 708, 808, 908, 1008, 1108 counter element
210, 510, 610, 710, 810, 910, 1010, counter element
112, 212, 312, 512, 612, 712, 812, 912, 1012, 1112 sensor element
214, 514, 614, 714, 814, 914, 1014 sensor element
215, 515, 715, 815 measuring module
116, 216, 316, 516, 716, 816, 916, 1116 pot connection
217, 517, 817 measuring module
218, 518, 818 pot connection
219, 519, 719, 819 evaluation module
120, 220, 320, 520, 720, 820, 1120 lower pot contact
221, 521, 821 lower pot contact
222, 822 lower pot contact
223, 523, 723, 823 lower pot contact
124 pot wall
126, 226, 526, 726, 826, 926, 1126 detection device
228, 528, 828 pot connection
229, 529, 729, 829, 929 pot connection
230, 530, 730, 830, 930, 1130 kitchen appliance
232, 532, 732, 832, 932, 1132 appliance base
234, 534, 734, 834, 934, 1134 pot receptable
236, 536, 736, 1136 base contact
237, 537 base contact
238 base contact
239, 539, 739 base contact
340 yoke
342 pot section
343 circumferential section of the pot section
346 winding
353, 355 ends of the yoke
560, 760, 1160 tool drive
661 open lid position
562, 762, 1162 kitchen appliance tools
663 lid position during the closing process
665 locked lid position
566, 766, 1166 display
667 lid position
751 pot connection
857 communication module
1071 signal curve of the sensors
1073 lid laid on loosely
1075 lid during locking movement
1077 lid locked
1170 locking mechanism
1172 mechanical coupling
1174 lid drive
1280, 1282, 1284 end positions
1281 unlocked
1283 locked
1285 no lid present
1287 position of the lid drive
1389, 1489 locked
1391, 1491 locked

1. A container arrangement for a kitchen appliance, comprising:
a food receiving element, and
at least one lid configured to close an opening of the pot,
wherein the lid is movable relative to the food receiving element between a first operating position and a second operating position different from the first operating position,
wherein the lid comprises at least a first magnetic field-based counter element,
wherein the food receiving element comprises at least one magnetic field-based sensor element connectable to a detection device, wherein the detection device is configured to detect a second operating state of the lid based on a first sensor datum,
wherein the magnetic field based sensor element is configured to output the first sensor datum only upon detection of the first magnetic field-based counter element in the detection range of the magnetic field-based sensor element, and
wherein the at least one first magnetic field-based counter element is arranged in the lid such that the magnetic field-based counter element is in the detection range of the magnetic field-based sensor element at least if the lid is in the second operating position.

2. The container arrangement according to claim 1, wherein the food receiving element comprises at least two magnetic field-based sensor elements arranged at an upper pot edge,
the two magnetic field-based sensor elements are located on substantially opposite sides of the pot edge, and
the lid comprises at least two first magnetic field-based counter elements arranged at a lid edge,
the two magnetic field-based counter elements are located on substantially opposite sides of the lid edge.

3. The container arrangement according to claim 1, wherein
the lid comprises at least one magnetic field-based additional counter element,
wherein the detection device is configured to detect a first operating state of the lid based on a second sensor datum,
the magnetic field-based sensor element is configured to output the second sensor datum only upon detection of the magnetic field-based additional counter element in the detection range of the magnetic field-based sensor element, and
the at least one magnetic field-based additional counter element is arranged in the lid such that the magnetic field-based additional counter element is in the detection range of the magnetic field-based sensor element only if the lid is in the second operating position.

4. The container arrangement according to claim 1, wherein
the at least one magnetic field-based sensor element is a coil, and
the at least one first magnetic field-based counter element is an inductive element formed of an inductance-influencing material.

5. The container arrangement according to claim 4, wherein
the container arrangement comprises at least a first lid and a second lid different from the first lid,
the at least one first inductive element of the first lid and the at least one second inductive element of the second lid are different from each other.

6. The container arrangement according to claim 4, wherein
the coil comprises a coil core in the form of a U-shaped yoke and at least one coil winding wound around the coil core,
the food receiving element comprises a coil cover, and
only the ends of the U-shaped yoke protrude through a respective opening in the coil cover.

7. The container arrangement according to claim 4, wherein
the food receiving element comprises at least two coils,
the food receiving element comprises a first electrical pot connection between a first coil contact of the first coil and a first lower pot contact,
the food receiving element comprises a second electrical pot connection between a first coil contact of the second coil and a second lower pot contact,
the food receiving element comprises a third electrical pot connection between a second coil contact of the first coil and a third lower pot contact, and
the food receiving element comprises a fourth electrical pot connection between a second coil contact of the first coil and the third lower pot contact,
the three lower pot contacts are configured to electrically connect to the detection device.

8. The container arrangement according to claim 4, wherein
the food receiving element comprises at least two coils,
the food receiving element comprises a first electrical pot connection between a first coil contact of the first coil and a first lower pot contact,
the food receiving element comprises a second electrical pot connection between a second coil contact of the second coil and a second lower pot contact,
the food receiving element comprises a fifth electrical pot connection between a second coil contact of the first coil and a first coil contact of the first coil, and
the two lower pot contacts are configured to electrically connect to the detection device.

9. The container arrangement according to claim 1, wherein
the at least one magnetic field-based sensor element is a magnetic field sensor, and
the at least one magnetic field-based counter element is a magnet.

10. The container arrangement according to claim 9, wherein
the container arrangement comprises at least a first lid and a second lid different from the first lid,
the at least one first magnet of the first lid is arranged in the first lid such that the magnetic field sensor detects a first magnetic field with a first magnetic field direction in the second operating position of the first lid, and
the at least one second magnet of the second lid is arranged on the second lid such that the magnetic field sensor in the second operating position of the second lid detects a second magnetic field with a second magnetic field direction different from the first magnetic field direction.

11. A kitchen appliance, comprising:
a container arrangement according to claim 1, and
an appliance base comprising a detection device connectable to the magnetic field-based sensor element of the food receiving element of the container arrangement,
wherein the detecting device is configured to detect a second operating state of the lid of the container arrangement based at least on the first output sensor data.

12. The kitchen appliance according to claim 11, wherein
a plurality of lid type criteria is predefined and a lid type is associated with each of the lid type criteria, and
the detection device is configured to identify the lid type based on at least one sensor signal received from the at least one magnetic field-based sensor element and the lid type criteria.

13. The kitchen appliance according to claim 12, wherein
the detection device is configured to determine at least one inductance value from at least one sensor signal received from a coil, and/or
the detection device is configured to determine at least one inductance value curve from at least one sensor signal received from a coil, and/or
the detection device is configured to determine at least one signal pattern from at least one sensor signal received from a magnetic field sensor, and/or
the detection device is configured to determine at least one signal pattern curve from at least one sensor signal received from a magnetic field sensor.

14. The kitchen appliance according to claim 11, wherein
the kitchen appliance comprises a lid drive configured to move a lid at least between the first operating position and the second operating position,
wherein the detection device is configured to detect at least one lid drive parameter value, and
the detecting device is configured to detect the second operating state of the container arrangement based on the detected lid drive parameter value and the first sensor datum.

15. A method of determining a second operating state in a container arrangement according to claim 1, comprising:
receiving, by a detection device, a first sensor datum output by the magnetic field-based sensor element, and
detecting, by the detecting device, the second operating state of the container arrangement based on the detected first sensor datum and at least one position criterion.
